(19) United States
(12) Patent Application Publication
(10) Pub. No.: US 2024/0061427 A1
(43) Pub. Date: Feb. 22, 2024

(54) METHOD AND SYSTEM FOR CONTROLLING THE HANDLING OF PRODUCTS

(71) Applicant: UBIQUICOM S.R.L., MILANO (IT)

(72) Inventors: Paolo CATTANEO, Milano (IT); Davide Raffaele RENZI, Milano (IT); Andrea BELISARIO, Milano (IT); Marco GUALTIERI, Milano (IT)

(73) Assignee: UBIQUICOM S.R.L., MILANO (IT)

(21) Appl. No.: 18/270,578

(22) PCT Filed: Dec. 29, 2021
(86) PCT No.: PCT/IB2021/062430

§ 371 Date: Jun. 30, 2023

(30) Foreign Application Priority Data
Dec. 30, 2020 (IT) 102020000032735

(51) Int. Cl. G05D 1/02; G06Q 10/047; G01C 21/20; B65G 1/04

(52) U.S. Cl. CPC G05D 1/021; G06Q 10/047; G01C 21/206; B65G 1/0492; G05D 2201/0216

(57) ABSTRACT

A computer-implementable method for controlling the handling of products in a warehouse is performed by acquiring a first item of data identifying a real-time position of a plurality of trolleys (A, B, C) inside the warehouse and a second item of data identifying a plurality of operations to be performed (1-9). A predictive model is applied to such data, generating a simulation of the handling of the trolleys (A, B, C) inside the warehouse during the performance of respective handling operations. As a function of such a simulation, a unique association is determined between each trolley and a respective group of operations to be performed (1-9) such as to minimise the overall time for the performance of the plurality of handling operations, which is then communicated to the individual trolleys (A, B, C). The present invention further relates to a system configured to carry out a method for controlling the handling of products in a warehouse.

### TECHNICAL FIELD

The present invention relates to the technical field of organising workflows in a product storage/sorting warehouse.

In particular, the present invention relates to a method for controlling the handling of products in a warehouse, in a factory, or in any work area which requires their handling.

Usually such handling processes are carried out by means of special trolleys capable of picking up the products and handling them inside the warehouse.

### PRIOR ART

In the reference sector it is known to manage the activities of trolleys by attributing a succession of missions to be performed to each of them.

Each mission represents a handling process of a product which must be performed and is mainly identified by means of information capable of identifying the position in which the product to be picked up is located and the position in which this product must be transported by means of the trolley to which the mission is entrusted.

In general, the loading/unloading stations and the storage positions of the products are in fixed and known positions inside the warehouse and therefore, as soon as a trolley is starting or finishing a handling operation of a product, it is possible to determine its position based on the information which identifies the mission it is carrying out.

Operationally, the known systems use the detected position of a trolley at the end of a mission to assign it the next mission, usually selecting the one which has a starting point, i.e., a point at which to pick up a product to be handled, which is as close as possible to its position.

Such an operating methodology allows to reduce the overall routes travelled by the individual trolleys, but has disadvantages which, in the face of relative management simplicity, prevent an overall optimisation of the handling flows inside the warehouse.

In fact, the procedure outlined above does not allow to know the actual position of the individual trolleys except at certain specific times and even in that case the detection is carried out passively, or by inferring the point where the trolley is as a function of the fact that it has just completed an operation which was to be carried out in a specific area of the warehouse.

It follows that the attribution of missions to individual trolleys is performed based on the assumption that there have been no errors and therefore that the trolley always starts and completes a mission in the correct position and does not even consider the possible position of other trolleys as they are not necessarily known.

Still in this context, it is also known to attribute the handling operations to be performed to the same trolley according to a specific sequence aimed at minimising the overall path which said trolley must travel.

However, such a solution also substantially presents the same problems outlined above.

In fact, also in this case the position of the trolleys is known only at specific intervals (i.e., at the completion of a given operation among those belonging to the group assigned to such a trolley) and is based only on the principle of attributing the minimum path available to each individual trolley, without however considering in an overall and global manner the actual position of each trolley inside the warehouse at any time and the relative proximity between the positions in which certain groups or subgroups of operations can/must be performed.

In other words, even in this case, the operations to be performed are assigned to an individual trolley simply by changing their order so as to reduce the length of the sections which said trolley must travel for the performance of each individual task and between one task and the next.

It follows that the optimisation of the handling flows to date is carried out locally, considering at a given instant only the optimal mission to be performed by a specific trolley without any overview, i.e., without evaluating in any manner whether a different trolley is present for example which could perform that same mission more efficiently at a later time.

### Object of the Invention

In this context, the technical task underlying the present invention is to provide a method for controlling the handling of products which obviates at least some of the drawbacks in the prior art as described above.

In particular, it is an object of the present invention to provide a method for controlling the handling of products capable of globally optimising the handling flows by more efficiently attributing distinct groups of missions to individual trolleys.

The set technical task and specified aims are substantially attained by a method for controlling the handling of products, comprising the technical features set out in one or more of the appended claims.

According to the present invention, a computer-implementable method for controlling the handling of products in a warehouse is shown.

The method is performed by continuously acquiring a first item of data identifying a real operating condition of a plurality of trolleys configured to handle the products.

In particular, the real operating condition comprises at least one real-time position of each trolley inside the warehouse.

The method is performed by further continuously acquiring a second item of data identifying a plurality of handling operations to be performed.

Each handling operation comprises at least one loading position and one unloading position of a respective product to be handled.

A predictive model is then applied to the first item of data and the second item of data, thereby generating a simulation of an ideal operating condition of the plurality of trolleys inside the warehouse during the performance of the respective handling operations.

Such an ideal operating condition operatively represents a simulation of the real operating condition and therefore includes all the same elements.

As a function of the simulation, a unique association is determined between each trolley and a respective group of handling operations to be performed such as to minimise the time for the performance of the plurality of handling operations.

Finally, a control signal identifying the respective group of handling operations to be performed is generated and transmitted to each trolley.

Advantageously, the proposed method allows for the overall processing and evaluation of the information provided by all the trolleys at every moment of their operation to determine the best strategy for assigning the handling operations to be performed.

In particular, contrary to what is suggested by the prior art, the method proposed herein involves detecting in real time (i.e., at all times) the real position of the trolleys and the division of the tasks to be performed is carried out by grouping them and assigning them so as to minimise the overall performance time necessary to carry them out.

The dependent claims, incorporated herein by reference, correspond to different embodiments of the invention.

### BRIEF DESCRIPTION OF THE DRAWINGS

Further features and advantages of the present invention will become more apparent from the indicative, and thus non-limiting, description of a preferred, but not exclusive, embodiment of a method for controlling the handling of products, as illustrated in the accompanying drawings, in which:

FIG. 1 shows a possible operating condition in which the method of the present invention is implemented;

FIGS. 2A and 2B schematically show some product handling steps inside a warehouse during the implementation of the method;

FIGS. 3A and 3B show the performance of an information acquisition procedure concerning the warehouse structure carried out in accordance with a possible aspect of the present method.

### DETAILED DESCRIPTION OF PREFERRED EMBODIMENTS OF THE INVENTION

Operationally, the method described herein can be implemented by a computer or by several computers connected to each other, including or defining, for example, a warehouse management system.

Although explicit reference is made below to examples of use inside a warehouse, the method can similarly be implemented in any structure in which handling and/or storage operations are carried out for products, such as sorting hubs and production plants.

In such a context, the method is carried out by collecting a plurality of information to be processed, according to the methods which will be explored below, as a function of which the best possible strategy for the management of product handling flows inside the warehouse is determined.

In particular, a first item of data identifying a real operating condition of a plurality of trolleys present inside the warehouse and configured to handle the products is continuously acquired.

The term trolleys is intended in a general sense to mean any handling means configured to perform an operation of moving one or more articles inside the warehouse.

By way of example, the term trolleys can therefore indicate self-propelled elements such as self-guided vehicles (for example robots) or not (for example forklifts as explicitly illustrated in the accompanying drawings) adapted to move inside the warehouse.

The term operating condition means information which allows to uniquely identify one or more parameters related to the operating status of the trolleys.

In particular, the real operating condition comprises at least one real-time position of each trolley inside the warehouse.

In other words, unlike in the known methodologies, the position of the trolleys in the warehouse is not deduced a posteriori for the individual trolley as a function of a state of progress of the missions attributed thereto, but is actively detected at all times.

It is thereby possible to always accurately and precisely know the actual position of all the trolleys which are operating inside the warehouse.

Advantageously, the operating condition can also comprise further information of interest such as an instantaneous speed and/or an average speed of movement of each trolley.

In detail, the instantaneous speed can be a parameter actively measured by suitable sensors while the average speed can be computed by the computer based on the instantaneous speeds measured in a specific time interval for each trolley.

The average speed can also be determined by the computer as a function of the positions detected for each trolley and the time interval between two successive measurements.

The operating condition can further comprise an operating status of each trolley.

The term operating status refers to information which can indicate, for example, the occurrence of faults which prevent the correct operation of the trolley or if such a trolley is actually available or is inactive (for example because maintenance is in progress).

Thus, in general, the method of the present invention is performed by acquiring a first item of data which allows the computer to know in real time at least the position of each trolley inside the warehouse and possibly also if, how and where such trolleys are moving.

The method further involves acquiring a second item of data which instead identifies a plurality of handling operations to be performed.

Each handling operation comprises and is defined by at least one loading position and one unloading position of a respective product to be handled.

In particular, the second item of data is acquired continuously so that whenever a new handling operation to be performed is generated, it is immediately notified to the computer and therefore taken into account for the performance of the subsequent steps of the method.

In other words, the method is carried out by continuously acquiring a list of missions which must be carried out, in which each mission uniquely defines the product to be handled indicating where the product is located (loading position at which it must be picked up by a trolley) and where it must be carried (unloading position at which the trolley must release it).

This information can be acquired by interfacing the computer and/or integrating the method described herein with warehouse management software, such as WMS (warehouse management system) software.

It should be noted that if the loading position is not sufficient to allow to uniquely identify the product to be handled, the respective handling operation is also identified by an identification code which allows to recognise the specific product of interest and which can for example comprise a barcode or an alphanumeric code.

Advantageously, each handling operation can be further identified by a priority level of said operation and/or by a maximum time limit within which said operation must be completed.

In general, therefore, the method of the present invention is performed by acquiring a second item of data which allows the computer to know all the handling operations which must be carried out by means of the trolleys present and active inside the warehouse and possibly also a degree of importance of such an operation and/or within what time such an operation must necessarily have been completed.

The method can be further performed by continuously acquiring also a third item of data by means of which an environmental condition of the warehouse is identified.

The term environmental condition means information which allows to identify the conditions of the warehouse with respect to events and situations potentially capable of altering the normal and correct operation of the trolleys as well as their performance of the handling operations defined by the second item of data.

For example, an environmental condition is considered as an information related to a travelability status of at least one area of the warehouse by means of which the computer is notified in real time if at a given instant a certain area of the warehouse is actually passable by the trolleys or not.

A further example of environmental condition is given by any predefined speed limits inside the different areas of the warehouse and preferably also by their crowding status, or by the number of trolleys already present and handling articles inside such areas.

Therefore, in determining and assigning to the individual trolleys of the respective handling trolleys, the handling paths followed/attributed to the other trolleys operating inside the same warehouse are also evaluated.

This avoids the risk of transit of an excessively large number of trolleys along the same trajectories. Therefore, the method is performed by acquiring a plurality of data which allow to identify the position of the trolleys, the handling operations to be performed and possibly also an overall situation of the warehouse in which such operations must be performed, all in real time.

A predictive model is then applied to such data by which a representative simulation of an ideal operating condition of the plurality of trolleys inside the warehouse is generated while these move during the performance of the plurality of handling operations to be performed.

In other words, the computer processes the first item of data, the second item of data and, if present, also the third item of data so as to simulate in a virtual environment the movements of the trolleys inside the warehouse while these perform the various handling operations required to bring the products from one point of the warehouse to another.

As a function of such a simulation, the computer determines which handling operations to assign to each trolley in order to minimise the overall performance time of the handling operations outlined by the second item of data.

In particular, the method is performed by determining as a function of the simulation a unique association between each trolley and a respective group of handling operations to be performed in a specific sequence such that the overall performance time of the plurality of handling operations to be performed is minimised.

Thereby the optimisation of the handling operations is not performed locally with respect to the individual trolleys, but in a global manner considering at all times and in a combined manner the information related to the operating conditions of all the trolleys operating inside the warehouse.

It should be noted that in an ideal situation where the speed of the trolleys inside the warehouse is always constant and equal to the maximum achievable speed, minimising the overall performance time of all the handling operations is equivalent to minimising the sum of the total routes travelled by all the trolleys in performing such operations and therefore reducing the sections travelled without load, i.e., the sections in which the trolleys move without moving products.

By way of example and for a better understanding of how the implementation of the method subject-matter of the present invention occurs, the accompanying drawings schematically show two possible implementation situations.

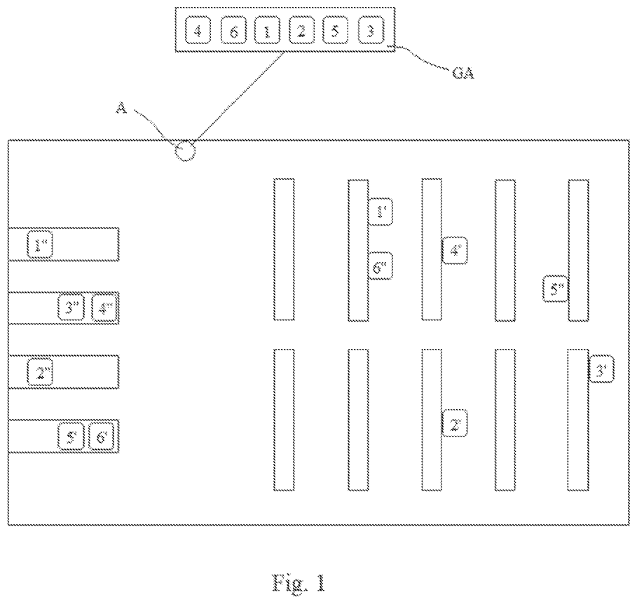

FIG. 1 shows a single trolley A (whose position is known by virtue of the first item of data) which must perform six handling operations (defined by the second item of data) identified by the numerical references 1 to 6 and characterised by the respective loading positions (references 1′ to 6′) and the corresponding unloading positions (references 1″ to 6″).

In accordance with the prior art, the trolley A should be attributed operation 1 since it has the loading position 1′ closest to the real position of the trolley A which will be followed by the operation 6 which has the loading point 6′ closest to the unloading position 1″ of operation 1.

Advantageously, however, the performance of the method described herein allows to simulate the ideal handling of the trolley A, determining that by making it perform the operations in the order indicated, in the order 4, 6, 1, 2, 5 and 3 (defining the group of operations indicated as GA), it is possible to minimise the total movements to be performed thus allowing to complete the performance of the six operations in less time.

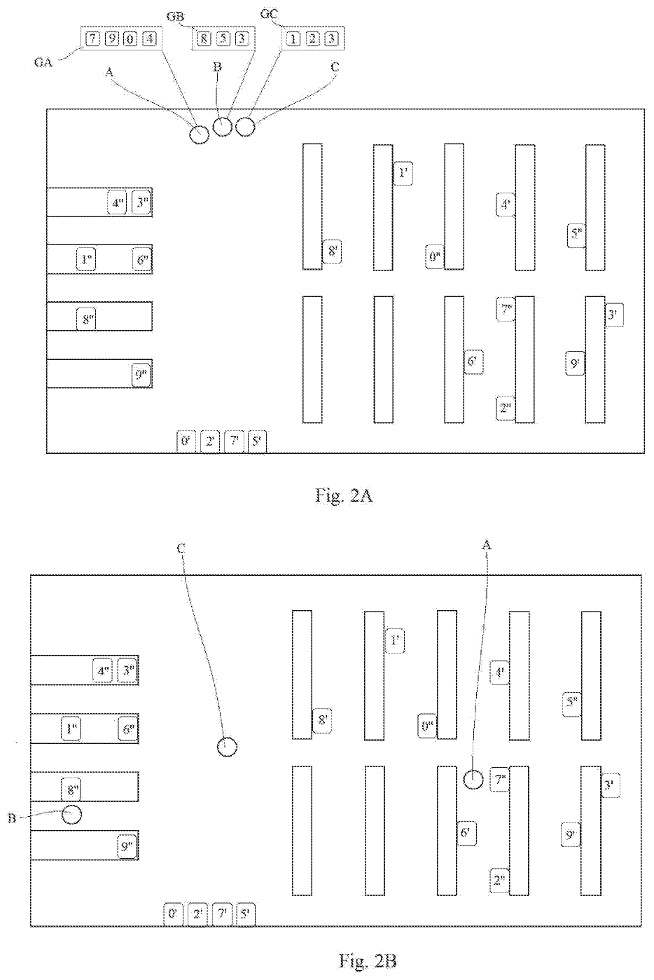

FIGS. 2A to 2C instead show a situation in which three trolleys are active, identified with references A, B and C, and ten handling operations to be performed identified by numerical references 0 to 9 and characterised by respective loading positions (references 0′ to 9′) and by the corresponding unloading positions (references 0″ to 9″).

In detail, the trolley indicated in the figures with reference A is associated with the group of operations GA, the trolley indicated in the figures with reference B with the group of operations GB and the trolley indicated in the figures with reference C is associated with the group of operations GC.

FIG. 2A shows how initially the first item of data communicates to the computer that the trolleys are all in the same position and therefore the attribution of a first handling operation to be performed is carried out by identifying, for example, the three operations with the closest loading position and randomly or arbitrarily associating each of these operations to a respective trolley.

For example, the trolley A is assigned the operation 7 to be performed between the positions 7′ and 7″, the trolley B the operation 8 to be performed between the positions 8′ and 8″ and the trolley C the operation 1 to be performed between the positions 1′ and 1″.

The computer then simulates the handling of the trolleys A, B and C while they perform the assigned operation and determines the distribution of the operations to be performed among such trolleys which allows to optimise the performance of the entire list of operations communicated to the computer by means of the second item of data.

In particular, in FIG. 2B it can be seen that trolley A has completed operation 7 and if the known art were applied, the performance of operation 6 would be attributed thereto since the corresponding loading position 6′ is the loading position closest to the current position of trolley A among all the loading positions of the operations still to be performed.

Advantageously, however, the performance of the method described herein allows to know and predict the position of each trolley A, B and C when operation 7 is completed, determining that it is possible to obtain better performance by attributing operation 9 (which has a loading position 9′ farther away from the loading position 6′) to trolley A since it is envisaged that attributing operation 6 to trolley C will allow to reduce the overall time of performance of all ten operations since it is simulated that such a trolley will be in a position (unloading position 2″) which will allow it to perform operation 6 more efficiently with respect to trolley A to which a different operation is therefore attributed.

In other words, the application of the method allows to have a global and overall view of all the operations to be performed and how each trolley operates during the handling of the products, attributing respective groups of operations to be performed to each thereof in order to optimise the product handling flows inside the warehouse.

Finally, a control signal identifying the respective group of handling operations is transmitted to each trolley.

In other words, each trolley is notified of the list of handling operations for which it is responsible and which it must carry out.

Advantageously, the method described herein is applicable in contexts in which the trolleys comprise self-guided vehicles, human-guided vehicles or a combination of both.

In fact, if the control signal is sent to a self-guided vehicle, it autonomously and automatically determines and controls the handling of the vehicle inside the warehouse.

If, on the other hand, the control signal is sent to an operator-guided vehicle, it presents an ordered and sequential list of handling operations which must be performed by the operator.

Therefore, the operator is not left the burden of making decisions on the performance methods of the handling operations, allowing him to focus on preventing, avoiding and possibly resolving any unforeseen situations which may arise, such as those communicated to the computer by means of the third item of data.

To cope with any changes in the information acquired by the computer which could have an impact on the results of the generated simulation, a plurality of situations are included in response to which the computer reruns the generation of the simulation, applying the predictive model to the updated data.

In accordance with a first aspect, the predictive model is applied by performing the simulation whenever a variation of the second item of data determined by the acquisition of one or more new handling operations to be performed occurs.

In other words, when updates occur for which new handling operations to be performed are generated, a new simulation is performed to verify how to modify the groups of operations associated with each trolley to introduce such new operations, i.e., to which trolleys to assign the new operations and in what order to have them performed with respect to the operations already assigned.

Additionally or alternatively, in accordance with a second aspect, a comparison is made at any time between the real operating condition of each trolley (acquired in real time by means of the first item of data) and the respective ideal operating condition (generated by the simulation) and the predictive model is applied whenever the two items of information are different or have differences greater than a predefined threshold value.

In other words, the generation of a new simulation is triggered when a discrepancy above a predefined threshold is detected between the real information acquired in real time and the corresponding information deriving from the simulation, i.e., if the simulation excessively deviates from the real situation which is detected.

Such a deviation can be defined as both an absolute value and a percentage value or as a generic change of status of one or more trolleys.

For example, the generation of a new simulation can be triggered when the real position of at least one trolley is more than 50 metres from its simulated ideal position.

Again, for example, if the first item of data also indicates the speed of movement of the trolleys, the generation of a new simulation can be triggered when the actual speed of at least one trolley is not comprised between 0.8 and 1.2 times its simulated ideal speed.

Again for example, if the first item of data also identifies an operating status of the trolleys, the generation of a new simulation can be triggered whenever a change in such an operating status occurs for at least one trolley (for example in response to the occurrence of a failure of one of the trolleys).

To avoid the computation time required by the computer for the performance of the simulation and the determination of the optimal assignment of the various handling operations to be performed from requiring excessively long times, the method involves the execution of a self-monitoring procedure which allows to automatically modulate the accuracy of the simulation, so as to make the timing necessary for its generation compatible with the operating dynamics of the warehouse.

In particular, if the time required to generate the simulation is greater than the average time which elapses between two successive events adapted to trigger the generation of a new simulation, the accuracy of such a simulation is automatically reduced so as to consequently also reduce the time necessary to generate it until they become less than the average time.

Operationally, an average time interval is determined between consecutive events which trigger the performance of the application step of the predictive model and the time horizon of the simulation is determined as a function of such an average time interval.

This ensures that the computation time required to generate the simulation is less than the average time interval and that the simulation is complete before an event occurs which triggers a new generation.

In this context, the term time horizon refers to the validity interval to which the predictive model is applied and within which the simulation is evaluated and generated.

By way of example, such a validity interval can be a time value, thus the simulation is generated to simulate the ideal operating conditions of the trolleys for a certain time interval or up to a predefined time.

Alternatively or additionally, the validity range can refer to a dimension of the group of handling operations which are attributed to the trolleys, thereby the simulation is not generated so as to sort all the operations to be performed but only a part thereof.

In other words, in accordance with the examples outlined herein by way of non-limiting example, under ideal conditions the predictive model is performed with an infinite time horizon, i.e., generating a simulation which sorts all the handling operations to be performed communicated to the computer by the second item of data and which includes the operating conditions of all the trolleys until the time when all the handling operations have been completed.

However, if events occur which significantly change the operational context of the method before the simulation has been completed, for example one or more of the events described above, it is possible to reduce such a time horizon so as to simultaneously reduce the computational time necessary for the generation of the simulation.

Such an aspect is particularly advantageous in very dynamic contexts in which there are frequent variations of the second item of data or in large warehouses in which numerous trolleys operate, making it more onerous to process the first item of data from a computational point of view.

In accordance with a particular aspect of the present invention, the method further comprises a preparation/installation procedure in which information concerning the shape of the warehouse and the structure/arrangement of the elements present therein are acquired by the computer as well as indications regarding the possible paths which the trolleys can follow to move between the loading positions and the unloading positions.

In detail, such a procedure is performed by acquiring a floor plan of the warehouse and defining therein a plurality of transitable areas, or areas within which the trolleys are authorised to move Such transitable areas can for example be defined by a plurality of adjacent and non-overlapping discrete positions in which one trolley can stop or transit at a time.

A plurality of paths which can be travelled by the plurality of trolleys inside the warehouse to reach and/or cross the plurality of transitable areas are also defined within the acquired floor plan.

In other words, all the possible and distinct paths along which the trolleys can move to bring the products from a loading position to an unloading position are identified.

It is thereby possible to precisely and accurately determine a well-defined set of trajectories and therefore positions which can be assumed by a trolley while performing a given handling operation, simplifying the process of applying the predictive model and thus reducing the time required for the generation of the simulation.

In this context, the simulation generated by applying the predictive model actually creates a representation of the movement of each trolley along a respective path for the performance of a handling operation.

Advantageously, a plurality of non-transitable areas can also be defined within the floor plan, i.e., areas within which not only is the transit of the trolleys not envisaged, or a path which can be covered by them is not defined, but their stopping or transit is not authorised, for example due to the presence of physical obstacles or because their presence/passage could create risks for the safety of the personnel present in the warehouse.

By way of example, the non-transitable areas comprises at least one among: loading and/or unloading stations of the products, fixed obstacles, pedestrian walkways.

Another type of possible non-transitable areas are the storage/warehousing positions of the products within which the products whose acquisition and identification procedure, however, has some peculiarities further explained in the following.

Such loading and/or unloading areas or storage/warehousing positions can in particular comprise shelves adapted to receive the articles to be handled inside the warehouse.

In this context, the specific structure and type of such shelves is also taken into account both with regard to the determination of the paths to be followed and that of the environmental conditions of the warehouse.

In particular, certain types of shelves could have a configuration such as to allow both loading and unloading articles from the same position and/or from positions adjacent to each other, or other different types of shelves could have a structure such as to allow or require the release of the articles to the shelves in different and distinct positions with respect to those in which the trolleys can pick them up.

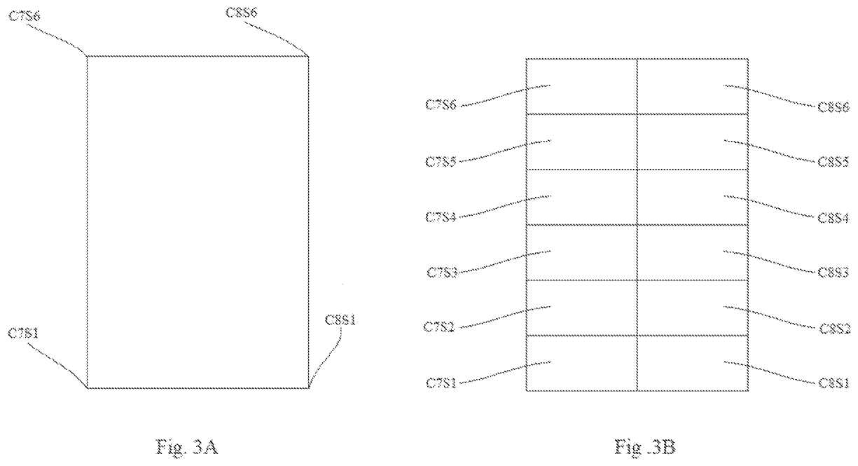

In particular, as shown in FIG. 3A, the identification in the floor plan of the plurality of product storage positions is performed by acquiring a storage area defined within the floor plan together with a reference identification code by which it is possible to identify the individual storage positions placed at the vertices of such a storage area.

Each storage position can be adapted to store a single product or a predefined number of similar, related or identical products.

In particular, the situation depicted refers to a storage area which is delimited between the seventh aisle and the eighth aisle and between the first shelf and the sixth shelf and therefore the storage positions placed at the end of the area can be identified in this context with the following reference identification codes: C7S1, C7S6, C8S1 and C8S6 (where the first two symbols indicate the aisle in which the position is located and the last two indicate the shelf).

As shown in FIG. 3B, the storage area is then automatically divided into a plurality of storage positions, associating each storage position with an identification code as a function of the reference identification codes C7S1, C7S6, C8S1 and C8S6.

In particular, six storage positions accessible from the seventh aisle are defined (which are then defined overall with the identification codes from C7S1 to C7S6) and six storage positions accessible from the eighth aisle (which are therefore defined overall with the identification codes from C8S1 to C8S6).

An object of the present invention is also a system by which to control the handling of products inside the warehouse.

In particular, the system is configured to perform the method described above.

From a structural point of view, the system comprises at least one interface module configured to continuously acquire the first item of data and the second item of data.

Such an interface module can for example comprise one or more acquisition devices capable of detecting the first item of data, connecting with a trolley control unit, preferably through a wireless connection protocol (such as Wi-Fi® or Bluetooth® protocols) and capable of detecting the second item of data by interfacing, for example, with warehouse management software (such as the aforementioned WMS).

The system further comprises a processing module capable of receiving the first and second item of data from the interface module and configured to apply the predictive model, generating the representative simulation of the operating conditions of the various trolleys during the performance of respective missions.

The simulation generated by the processing module is then processed by a computing module, which determines the unique association between each trolley and the respective group of operations to be performed, so as to minimise the time for the performance of the plurality of handling operations defined by the second item of data.

Finally, the system comprises a transmission module configured to generate and to transmit a respective command signal to each trolley (A, B, C), so as to specify thereto which group of handling operations to be performed has been assigned thereto.

Advantageously, the present invention achieves the proposed objects, overcoming the drawbacks complained of in the prior art by providing the user with a method and a system for controlling the handling of products inside a warehouse through which it is possible to obtain a global and overall optimisation in the use of the available resources and in the programming of the product handling flows.

1. A computer-implementable method for controlling the handling of products in a warehouse, comprising the steps of:
continuously acquiring a first item of data identifying a real operating condition of a plurality of trolleys (A, B, C) configured to handle the products, said real operating condition comprising at least one real-time position of each trolley (A, B, C) inside the warehouse;
continuously acquiring a second item of data identifying a plurality of operations to be performed (1-9), each handling operation comprising at least one loading position (1′-9′) and one unloading position (1″-9″) for a respective product to be handled.
applying a predictive model to said first and second items of data, thereby generating a simulation of an ideal operating condition of the plurality of trolleys (A, B, C) inside the warehouse during the performance of respective handling operations;
determining, as a function of said simulation, a unique association between each trolley (A, B, C) and a respective group of handling operations to be performed (1-9) in a specific sequence such as to minimise the time for the performance of the plurality of handling operations;
transmitting to each trolley (A, B, C) a control signal identifying the respective group of handling operations to be performed (1-9).

2. The method according to claim 1, wherein the step of applying a predictive model is performed every time a variation occurs in the second item of data as a result of the acquisition of one or more new handling operations to be performed (1-9).

3. The method according to claim 1, comprising a step of comparing, in every instant, the ideal operating condition of each trolley (A, B, C) with the respective real operating condition and wherein the step of applying a predictive model is performed every time the real operating condition differs from the ideal operating condition beyond a predefined threshold value.

4. The method according to claim 1, wherein the real operating condition further comprises an instantaneous and/or an average speed of movement of each trolley (A, B, C).

5. The method according to claim 1, wherein the real operating condition comprises an operating status of each trolley (A, B, C).

6. The method according to claim 1, comprising a step of continuously acquiring a third item of data identifying an environmental condition of the warehouse, said environmental condition comprising at least one travelability status of at least one area of the warehouse, said step of applying a predictive model being performed every time a variation occurs in the third item of data.

7. The method according to claim 2, comprising the steps of:
determining an average time interval between consecutive events which determine the performance of the step of applying a predictive model;
determining a time horizon of the simulation as a function of said average time interval, so that a computing time necessary for generating the simulation is less than said average time interval.

8. The method according to claim 1, comprising the steps of:
acquiring a floor plan of the warehouse;
defining in said floor plan a plurality of transitable areas;
defining in said floor plan a plurality of paths that can be travelled by the plurality of trolleys (A, B, C) inside the warehouse to reach and/or pass through the plurality of transitable areas;
said simulation being representative of a movement of each trolley (A, B, C) along a respective path.

9. The method according to claim 8, comprising a step of defining in said floor plan a plurality of non-transitable areas, said non-transitable areas comprising at least one among: product loading and/or unloading stations, fixed obstacles and pedestrian walkways.

10. The method according to claim 9, comprising a step of identifying in said floor plan a plurality of product storage positions, comprising the sub-steps of:
acquiring a storage area and a reference identification code (C7S1, C7S6, C8S1, C8S6) adapted to identify storage positions at the vertices of said storage area;
dividing the storage area into a plurality of storage positions, associating each storage position with a respective identification code as a function of the reference identification codes (C7S1, C7S6, C8S1, C8S6).

11. A system configured to carry out a method for controlling the handling of products in a warehouse according to claim 1, comprising:
at least one interface module for continuously acquiring the first item of data and the second item of data;
a processing module configured to apply the predictive model to said first and second items of data, thereby generating the simulation;
a computing module configured to determine, as a function of the simulation, the unique association between each trolley (A, B, C) and the respective group of handling operations to be performed (1-9) so as to minimise the time for the performance of the plurality of handling operations;
a transmission module configured to generate and to transmit a respective command signal to each trolley (A, B, C) so as to specify thereto the respective group of handling operations to be performed.
